(19) United States
(12) Patent Application Publication
(10) Pub. No.: US 2004/0220321 A1
(43) Pub. Date: Nov. 4, 2004

(54) Rubber composition usable as a safety support for a tire and said support

(76) Inventors: Francois Bataille, St-Amant-Tallande (FR); Serge Teisseyre, Clermont-Ferrance (FR)

Correspondence Address: Michelin North America, Inc., Intellectual Property Department, P.O. Box 2026, Greenville, SC, 29602, US

(21) Appl. No.: 10/229,995

(22) Filed: Aug. 28, 2002

Related U.S. Application Data
(63) Continuation of application No. PCT/EP01/15251, filed on Dec. 21, 2001.

(30) Foreign Application Priority Data
Jan. 2, 2001 (FR) 01/00050

(51) Int. Cl. C08F 36/00

(52) U.S. Cl. 524/493; 524/571; 525/331.9; 525/333.9

(57) ABSTRACT

The present invention relates to a rubber composition, usable in the vulcanized state as a safety support intended to be mounted on a wheel rim within a tire, such a support being able to support a tread of said tire in the event of a drop in inflation pressure, a process for the preparation of said composition, and a mounted assembly comprising this support.

A composition according to the invention, which comprises at least one diene elastomer, is such that it also comprises (phr: parts by weight per 100 parts of diene elastomer(s)):

solid or hollow glass microbeads, in a quantity of from 5 to 50 phr,

more than 40 phr of reinforcing filler, and

3 to 8 phr of sulphur.

The present invention relates to a rubber composition, usable in the vulcanized state as a safety support intended to be mounted on a wheel rim within a tire, such a support being able to support a tread of said tire in the event of a drop in inflation pressure, to a process for the preparation of said composition, and to a mounted assembly comprising this support.

In known manner, safety supports for a vehicle tire are intended to be mounted on a rim inside the tire, in order to be able to support the tread of this tire in the event of a loss of inflation pressure. These supports comprise in particular a base which is intended to be mounted on the rim, and a crown which is intended to come into contact with the tread in the aforementioned case and which leaves a clearance therefrom at nominal pressure.

Japanese patent specification JP-A-3/82601 discloses such a support, the base and the crown of which are substantially cylindrical, and which furthermore comprises an annular body connecting said base and said crown.

This annular body comprises a supporting element which is circumferentially continuous, and which comprises:

a plurality of partitions extending axially on either side of said circumferential median plane and distributed over the circumference of said support, and

joining elements extending substantially circumferentially, each joining element connecting together the two respective ends of two adjacent partitions which are arranged on the same side of the support, said joining elements being arranged successively alternately on either side of said partitions;

in which the partitions and joining elements are substantially rectilinear and the difference between the maximum and minimum values of the area of an axial section of the supporting element as a function of the azimuth, relative to the total of these same areas, is preferably less than 0.3. Consequently, as a function of the azimuth, the area of an axial section of the supporting element varies at most by a factor of two in order to obtain good uniformity of loading capacity and to limit the vibrations when travelling in a support configuration.

This support is made essentially of a hard polymer material and the entire supporting element is designed to be able to support the compressive load.

Such supports may be produced in conventional manner by injection in a mold, for example.

European patent specification EP-A-1 116 606 in the name of the Applicant discloses a rubber composition for a safety support comprising (phr: parts by weight per 100 parts of diene elastomer(s)):

natural rubber or synthetic polyisoprene, in a quantity equal to or greater than 60 phr,

more than 60 phr of a reinforcing white filler, and

3 to 8 phr of sulphur.

Furthermore, safety supports based on a plastics material or an elastomeric material, such as a hardened rubber, or alternatively based on a mixture of this elastomeric material and glass, carbon or other fibres are known from U.S. Pat. No. 5,141,039 (column 4, lines 18-22).

The Applicant has surprisingly discovered that a rubber composition based on at least: (phr: parts by weight per 100 parts of diene elastomer(s)):

a diene elastomer,

solid or hollow glass microbeads, in a quantity of from 5 to 50 phr,

more than 40 phr of reinforcing filler, and

from 3 phr to 8 phr of sulphur,

has in the non-vulcanized state a processing ability which is improved compared with that of known compositions for safety supports and, in the vulcanized state, physical and hysteresis properties which are also improved, which make it particularly well suited for forming in the vulcanized state a safety support intended to be mounted on a wheel rim within a tire.

It will be noted that the invention relates equally well to the rubber compositions in the non-vulcanized state and in the vulcanized state.

As far as said elastomer(s) are concerned, “diene elastomer” is understood in known manner to mean an elastomer resulting at least in part (i.e. a homopolymer or a copolymer) from diene monomers (monomers bearing two double carbon-carbon bonds, whether conjugated or not).

Preferably, it will be noted that said elastomer(s) are formed of at least one essentially unsaturated diene elastomer.

“Essentially unsaturated” diene elastomer is understood to mean a diene elastomer which has resulted at least in part from conjugated diene monomers having a content of members or units of diene origin (conjugated dienes) which is greater than 15% (mole %), and for example:

a) any homopolymer obtained by polymerization of a conjugated diene monomer, such as 1,3-butadiene, 2-methyl-1,3-butadiene (or isoprene), 2,3-di(C1 to C5 alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene or phenyl-1,3-butadiene.

b) any copolymer obtained by copolymerization of one or more dienes conjugated together or with one or more vinyl aromatic compounds, such as styrene, ortho-, para- or meta-methylstyrene. Mention may be made, for example, of butadiene-styrene copolymers, or butadiene-isoprene copolymers.

According to one example of embodiment of the invention, said composition comprises a single diene elastomer which consists entirely of natural rubber or synthetic polyisoprene.

According to a variant embodiment of the invention, the composition comprises a blend:

in a quantity equal to or greater than 60 phr, of natural rubber or synthetic polyisoprene, and

in a quantity less than or equal to 40 phr, of a homopolymer obtained by polymerization of a conjugated diene monomer having 4 to 12 carbon atoms, or of a copolymer obtained by copolymerization of one or more dienes conjugated together or with one or more vinyl aromatic compounds having from 8 to 20 carbon atoms.

Said composition may then comprise, for example, a blend of approximately 60 phr natural rubber and approximately 40 phr polybutadiene.

The reinforcing filler of a rubber composition according to the invention preferably comprises a majority portion of a reinforcing white filler, that is to say in a mass fraction which is greater than 50%.

“Reinforcing white filler” is understood to mean a white filler which is capable, on its own, without any other intermediate means than a white filler/elastomer(s) coupling agent, of reinforcing a rubber composition intended for the manufacture of tires, in other words which is capable of replacing a conventional tire-grade carbon black filler in its reinforcement function.

Such a reinforcing white filler may for example consist of silica, and it is advantageously present in said composition in a quantity of from 40 to 80 phr and, even more advantageously, in a quantity of from 55 to 70 phr.

All the precipitated or pyrogenic silicas known to the person skilled in the art which have a BET or CTAB surface area of a value greater than 100 m²/g are suitable as silicas capable of being used, even if highly dispersible precipitated silicas are preferred.

“Highly dispersible silica” is understood to mean any silica having a very substantial ability to disagglomerate and to disperse in an elastomeric matrix, which can be observed in known manner by electron or optical microscopy on thin sections. As non-limitative examples of such highly dispersible silicas which can be used for the invention, mention may be made of the silicas BV 3370 and BV3380 from Degussa, the silicas Zeosil 1165 MP and 1115 MP from Rhodia, the silica BXR 160 from PPG or the silica Zeopol 8745 M from Huber.

Preferably, a silica is used, the value of BET or CTAB surface area of which is of between 110 and 200 m²/g and, even more preferably, between 140 and 195 m²/g.

Of course, “silica” is also understood to mean blends of different silicas. The silica may be used alone or in the presence of other white fillers. The value of the CTAB specific surface area is determined in accordance with the method of Standard NFT 45007 of November 1987. The value of the BET specific surface area is determined in accordance with the method of BRUNAUER, EMMETT and TELLER described in “The Journal of the American Chemical Society, vol. 80, page 309 (1938)”, corresponding to Standard NFT 45007 of November 1987.

As reinforcing white filler, there may also be used, in non-limitative manner,

aluminas (of formula Al₂O₃), such as the aluminas of high dispersibility which are described in European Patent Specification EP-A-810 258, or alternatively

aluminum hydroxides, such as those described in International Patent Specification WO-A-99/28376.

The reinforcing filler used for the composition of the invention may comprise grade 6 or 7 carbon black as minority proportion, that is to say, in a mass fraction of less than 50%. For example, the blacks N683 and N772 may be used for this purpose.

Also suitable as reinforcing filler according to the invention are carbon blacks partially or completely covered with silica.

The rubber composition according to the invention furthermore comprises, in conventional manner, when said reinforcing filler comprises a reinforcing white filler, a reinforcing white filler/elastomer(s) bonding agent (also referred to as coupling agent), the function of which is to ensure sufficient chemical and/or physical bonding (or coupling), between said white filler and said elastomer(s), while facilitating the dispersion of this white filler within the latter.

Such a bonding agent, which is at least bifunctional, has, for example, the simplified general formula “Y-T-X”, in which:

Y represents a functional group (“Y” function) which is capable of bonding physically and/or chemically with the white filler, such a bond possibly being established, for example, between a silicon atom of the coupling agent and the hydroxyl (OH) surface groups of the filler (for example, surface silanols in the case of silica);

X represents a functional group (“X” function) which is capable of bonding physically and/or chemically with the elastomer, for example by means of a sulphur atom;

T represents a hydrocarbon group making it possible to link Y and X.

These bonding agents must in particular not be confused with simple agents for covering the filler in question which, in known manner, may comprise the Y function which is active with respect to the filler, but are devoid of the X function which is active with respect to the elastomer.

Such bonding agents, of variable effectiveness, have been described in a very large number of documents and are well known to the person skilled in the art. In fact, any bonding agent known to or likely to ensure, in the diene rubber compositions usable for the manufacture of tires, the effective bonding between the silica and diene elastomer, such as, for example, organosilanes, in particular polysulphurized alkoxysilanes or mercaptosilanes.

In particular polysulphurized alkoxysilanes, which are referred to as “symmetrical” or “asymmetrical” depending on their specific structure, are used, such as those described for example in patents U.S. Pat. No. 3,842,111, U.S. Pat. No. 3,873,489, U.S. Pat. No. 3,978,103, U.S. Pat. No. 3,997,581, U.S. Pat. No. 4,002,594, U.S. Pat. No. 4,072,701, U.S. Pat. No. 4,129,585, or in the more recent patents U.S. Pat. No. 5,580,919, U.S. Pat. No. 5,583,245, U.S. Pat. No. 5,650,457, U.S. Pat. No. 5,663,358, U.S. Pat. No. 5,663,395, U.S. Pat. No. 5,663,396, U.S. Pat. No. 5,674,932, U.S. Pat. No. 5,675,014, U.S. Pat. No. 5,684,171, U.S. Pat. No. 5,684,172, U.S. Pat. No. 5,696,197, U.S. Pat. No. 5,708,053, U.S. Pat. No. 5,892,085, EP-A-1 043 357 which describe such known compounds in detail.

Particularly suitable for the composition of the invention, without the definition below being limitative, are so-called “symmetrical” polysulphurized alkoxysilanes which satisfy the following general formula (I):

Z-A-Sₙ-A-Z, (I) in which:

n is an integer from 2 to 8 (preferably from 2 to 5);

A is a divalent hydrocarbon radical (preferably C₁-C₁₈ alkylene groups or C₆-C₁₂ arylene groups, more particularly C₁-C₁₀ alkylenes, in particular C₂-C₄ alkylenes, in particular propylene);

Z corresponds to one of the formulae below:

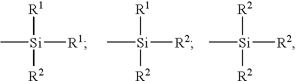

in which:

the radicals R¹, which may or may not be substituted, and may be identical or different, represent a C₁-C₁₈ alkyl group, a C₅-C₁₈ cycloalkyl group or a C₆-C₁₈ aryl group, (preferably C₁-C₆ alkyl groups, cyclohexyl or phenyl, in particular C₁-C₄ alkyl groups, more particularly methyl and/or ethyl);

the radicals R², which may or may not be substituted, and may be identical or different, represent a C₁-C₁₈ alkoxyl group or a C₅-C₁₈ cycloalkoxyl group (preferably C₁-C₈ alkoxyl groups or C₅-C₈ cycloalkoxyl groups, more particularly methoxyl and/or ethoxyl.

In the case of a mixture of polysulphurized alkoxysilanes in accordance with Formula (I) above, in particular conventional, commercially available, mixtures, it will be understood that the average value of the “n”s is a fractional number, which may preferably vary from 2 to 5.

Examples of polysulphurized alkoxysilanes are more particularly polysulphides (in particular tetrasulphides) of bis((C₁-C₄)alkoxyl-silylpropyl), in particular of bis(tri(C₁-C₄)alkoxyl-silylpropyl), in particular bis(3-trimethoxysilylpropyl) or bis(3-triethoxysilylpropyl) polysulphides. Of these compounds, preferably bis(3-triethoxysilylpropyl) tetrasulphide, abbreviated TESPT, of the formula [(C₂H₅O)₃Si(CH₂)₃S₂]₂, sold, for example by Degussa under the name Si69 (or X50S when it is supported to 50% by weight on carbon black), or alternatively by Witco under the name Silquest A1289, is used.

The person skilled in the art will be able to adjust the content of coupling agent in the compositions of the invention, according to the intended application, the elastomer or elastomers used and the quantity of reinforcing white filler used.

In the rubber compositions according to the invention, the content by weight of coupling agent may be within a range from 2 to 15% relative to the mass of reinforcing white filler, and, preferably, within a range from 5 to 12%.

As far as the amount of sulphur in the composition according to the invention is concerned, it will be noted preferably that it may vary from 3.5 to 5.5 phr.

The glass microbeads which are used in the composition according to the invention, be they solid or hollow (in this latter case, they are sometimes referred to as “glass bubbles”) have, by definition, a spherical form. Of course, microbeads which do not have exactly a geometry which is perfectly spherical, but spheroidal, are also usable in the safety support composition according to the invention.

The solid or hollow microbeads usable in the composition according to the invention may be based on varied constituents.

According to one example of embodiment of the invention, microbeads which are majoritarily based on soda-lime borosilicate, preferably in a mass fraction of at least 97%, are used. These microbeads also comprise silicon dioxide, in a mass fraction less than or equal to 3%.

The hollow microbeads are usable in a composition according to the invention in a quantity of from 5 phr to 50 phr, preferably from 10 phr to 30 phr and, even more preferably, from 15 phr to 25 phr.

These hollow microbeads have an average volume size (diameter) which is of between 10 μm and 400 μm. Preferably, this average volume size is between 10 μm and 100 μm and, even more preferably, between 15 μm and 65 μm.

Preferably, the hollow microbeads have before mixing a density equal to or greater than 0.55 g/cm³ and, even more preferably, equal to or greater than 0.60 g/cm³.

The solid microbeads are also usable in a composition according to the invention in a quantity of from 5 phr to 50 phr, preferably from 10 phr to 30 phr and, even more preferably, from 15 phr to 25 phr.

These solid microbeads also have an average volume size (diameter) which is of between 3 and 400 μm, preferably between 10 and 400 μm and, even more preferably, between 10 and 40 μm.

A preparation process according to the present invention for said vulcanized rubber composition is such that it consists essentially,

in a first, thermomechanical working, stage, of kneading said elastomer(s), said reinforcing filler and solid or hollow glass microbeads, the dropping temperature being approximately 155° C., then

in a second, mechanical working, stage, of adding a sulphur vulcanization system to the mixture obtained at the end of said first stage, then

in a third, vulcanization, stage, of curing the mixture obtained at the end of said second stage,

such that said microbeads are dispersed in said elastomer(s).

According to an example of implementation of the invention, this preparation process consists,

in said first stage, of effecting said kneading for a time for example close to 4 min., then

in said second stage, of effecting said addition at a temperature less than 100° C. and for a time for example of between 2 min. and 2.5 min., then

in said third stage, of effecting said curing at a temperature of between 140° C. and 170° C., for example substantially equal to 150° C., and for a time for example close to 8 min.

The rubber compositions according to the invention contain, in addition to said elastomer(s), said reinforcing filler, said glass microbeads and one or more reinforcing white filler/elastomer(s) bonding agents, all or part of the other constituents and additives usually used in rubber mixes, such as plasticizers, pigments, antioxidants, vulcanization accelerators, extender oils, one or more agents for covering the reinforcing white filler, such as alkoxysilanes, polyols, amines, etc.

According to another characteristic of the invention, the rubber composition has an elasticity modulus M10 at 10% deformation which is greater than 10 MPa and which is preferably greater than 15 MPa, for example equal to 16 MPa, which imparts satisfactory rigidity to the safety support formed of this composition.

A safety support according to the invention is such that it is formed by said rubber composition of the invention.

This support according to the invention is for example of the type comprising:

a substantially cylindrical base intended to be mounted on the rim,

a substantially cylindrical crown intended to come into contact with the tread of the tire in the event of a drop in pressure, and leaving a clearance relative to said tread at nominal pressure, and

an annular body connecting said base and said crown together, said body comprising a supporting element which is circumferentially continuous with a circumferential median plane, said supporting element comprising a plurality of partitions extending axially on either side of said circumferential median plane and distributed over the circumference of said support.

According to a first embodiment of this example of a support according to the invention, said annular body also comprises in one of said sides of the support joining elements extending substantially circumferentially, each joining element connecting together the respective ends of two adjacent partitions which are arranged on said side of the support, said joining elements being arranged successively alternately on either side of said partitions.

In this first embodiment, said joining elements are provided with a mutual shoulder, between two adjacent partitions, by a rib extending from said crown to said base of the support, such that said joining elements form a continuous joining wall in the form of a bellows over the entire side of said support.

More precisely, said joining wall comprises a plurality of cells which are each defined by two adjacent ribs, the bottom of each cell having substantially the form of a dihedron, the edge of which is formed by one of said partitions and the faces of which are respectively formed by said alternating joining elements.

According to a second embodiment of this example of a support according to the invention, said annular body also comprises, on both sides of the support, joining elements extending substantially circumferentially, each joining element connecting together the respective two ends of two adjacent partitions which are arranged on the same side of the support, said joining elements being arranged successively alternately on either side of said partitions.

In this second embodiment, said partitions are adapted in their central part relative to their lateral ends to reinforce the resistance to buckling under radial loading of the annular body.

In fact, the central part of the partitions of the supporting element is distanced from the joining elements and may be destroyed during travel in a support configuration by the appearance of repeated buckling deformation. In the case of supports made essentially of an elastomer material, such repeated buckling deformation may during travel cause firstly initiation then propagation of cracks on the side of the walls in extension. On the other hand, in the case of supports made essentially of plastic materials, buckling deformation involves the appearance of plastic deformations. These irreversible deformations greatly reduce the stiffness of the structure and its loading capacity, and make it gradually incapable of fulfilling its function.

The ratio between the thickness of the partitions in their central part and their lateral ends is greater than 1.1 and preferably greater than 1.5. This variation in thickness very substantially reinforces the resistance to buckling of the central part of the partitions and thus makes it possible, for a given radial load, to limit the thickness of the joining elements and to reduce the total weight of the support.

These partitions have, from one lateral end to the other, at least one inversion and, preferably, three inversions of the direction of their curvature.

These partitions have for example a central part extending substantially axially between two lateral parts, these lateral parts joining the joining elements, forming with the circumferential direction an angle γ of from 20 to 40 degrees.

According to another example of embodiment, the partitions have in their central zone two parts extending substantially axially and offset circumferentially relative to one another, and also a third joining part. The variation α in average orientation between this third joining part and the two parts of substantially axial orientation is preferably greater than 20 degrees.

Each joining element may be provided with a shoulder, on only one side or on both sides of the supporting element, by at least one wall extending substantially axially towards the outside of the annular body.

These axial walls are not very sensitive to buckling because they are integral with the supporting element and are relatively short. These axial walls make it possible, with an equal width of the support, to reduce the width of the supporting element and therefore to increase its resistance to buckling.

In a preferred embodiment, each joining element forms with an axial wall which provides it with a shoulder and the lateral ends of the two adjacent partitions an assembly in the form of a star having three branches, and the axial width of one axial wall is less than or equal to half of the axial width of the two adjacent partitions of the supporting element.

The supporting elements according to the invention may also comprise a web which is substantially cylindrical and coaxial with the support, which for example is arranged radially at half the height of the supporting element.

This web is made of the same material as the rest of the annular body. It makes it possible, when it is arranged at half the height, to divide the height of the partitions by two and thus to increase the limit buckling load by a factor of approximately four.

To facilitate the production of the supports according to the invention, the different geometries of the supporting elements are adapted so as not to comprise any undercut part which might oppose axial demolding of the support.

Preferably, a mounted assembly for an automobile is of the type comprising a wheel rim, a tire mounted on said rim and said support according to the invention, said rim comprising on each of its two peripheral edges a rim seat intended to receive a bead of said tire, said rim comprising between its two seats, on one hand, a bearing surface and, on the other hand, a mounting groove connecting said bearing surface to an axially inner flange of one of said seats, or first seat.

It will be noted that the flat structure which is imparted to said rim by said bearing surface is such that, when travelling with a flat tire, the entire width of the support supports the load, unlike what are called “drop-centre” rims.

The aforementioned characteristics of the present invention, as well as others, will be better understood on reading the following description of several examples of embodiments of the invention, which are given by way of illustration and not of limitation, in comparison with other examples not in accordance with the invention.

Examples of the architecture of a support according to the invention will be described at the end of the present description by means of the appended drawings, in which:

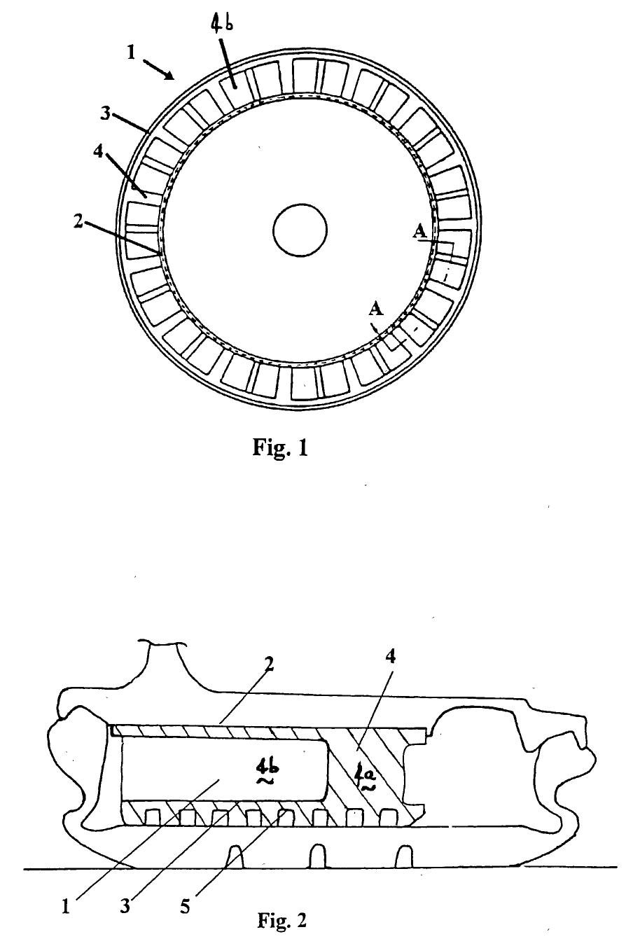

FIG. 1 is a side view of a safety support according to one embodiment of the invention,

FIG. 2 is a view in axial section of a mounted assembly according to the invention, in which the support of FIG. 1 is mounted on a wheel rim and is in the position of bearing against a tire,

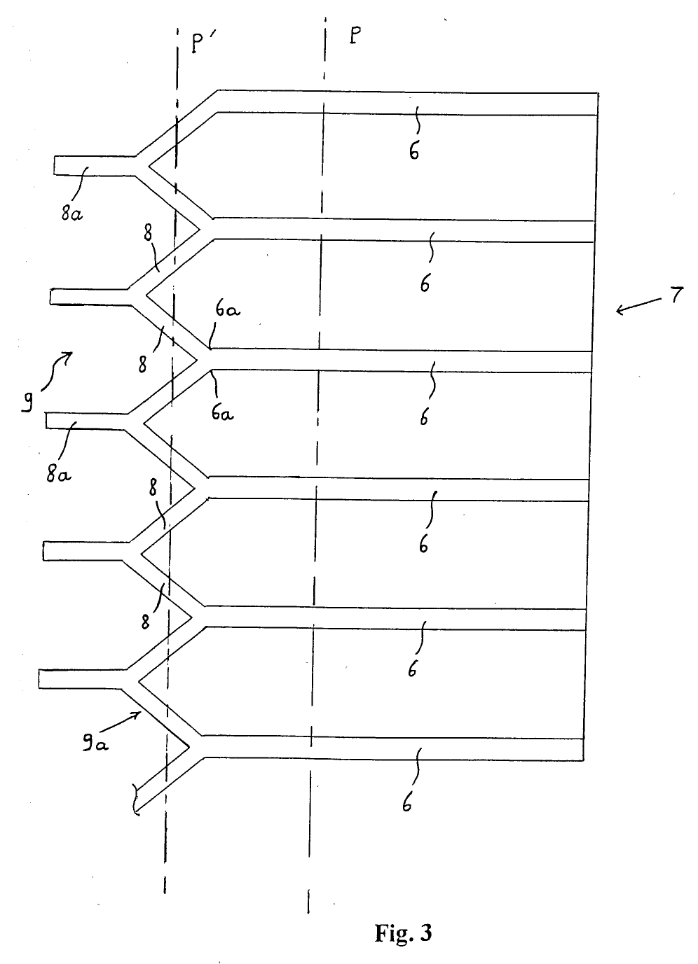

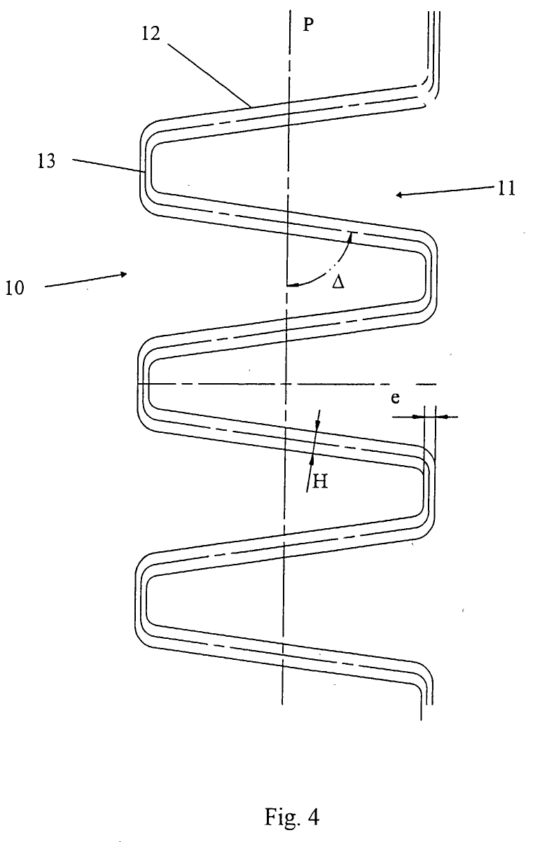

FIG. 3 is a sectional view, along the line AA of FIG. 1, of a supporting element according to a first embodiment of the invention,

FIG. 4 is a sectional view, along the line AA of FIG. 1, of a supporting element according to a second embodiment of the invention, which comprises partitions joined by alternating circumferential joining elements,

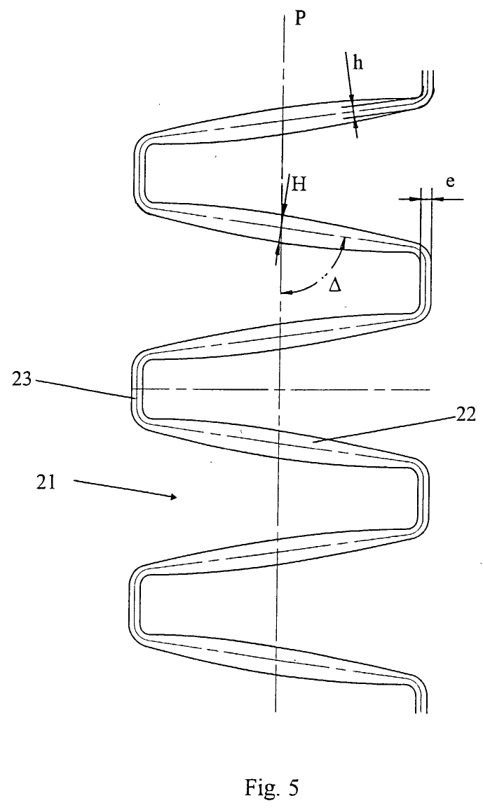

FIG. 5, which is similar to FIG. 4, is a sectional view, along the line AA of FIG. 1, of a supporting element having partitions of variable thickness,

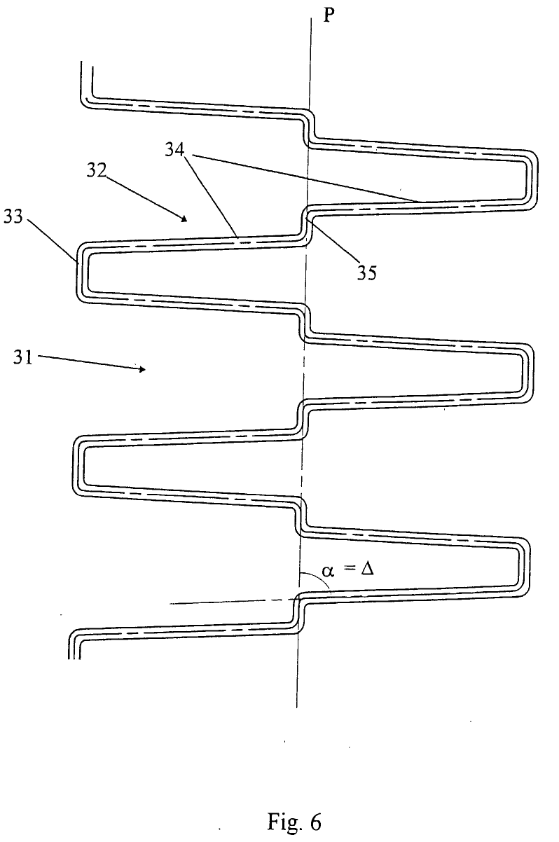

FIG. 6, which is similar to FIG. 4, is a sectional view, along the line AA of FIG. 1, of a supporting element, the partitions of which comprise a central connecting part which is oriented circumferentially,

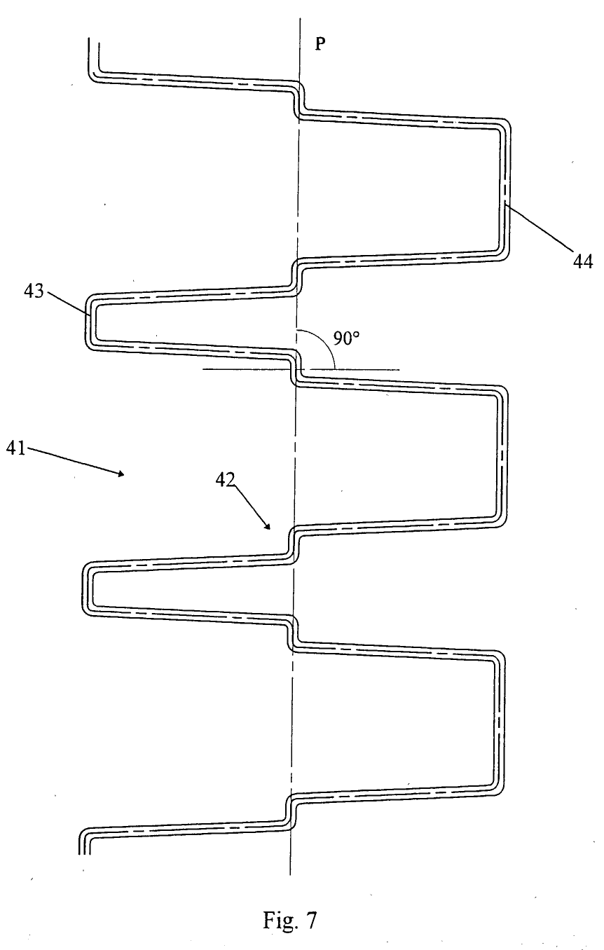

FIG. 7, which is similar to FIG. 4, is a sectional view, along the line AA of FIG. 1, of a supporting element, the circumferential joining elements of which have a variable length,

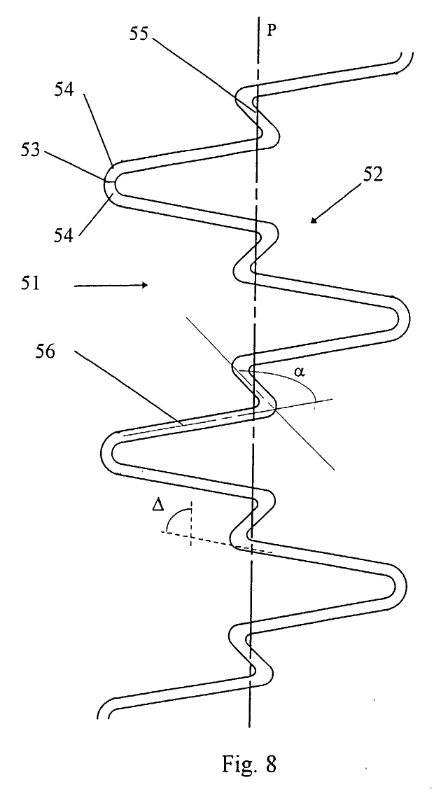

FIG. 8, which is similar to FIG. 4, is a sectional view, along the line AA of FIG. 1, of a supporting element, the partitions of which have three inversions of curvature in their width,

FIG. 9, which is similar to FIG. 4, is a sectional view, along the line AA of FIG. 1, of an annular body including another embodiment of a supporting element, the partitions of which have three inversions of curvature in their width,

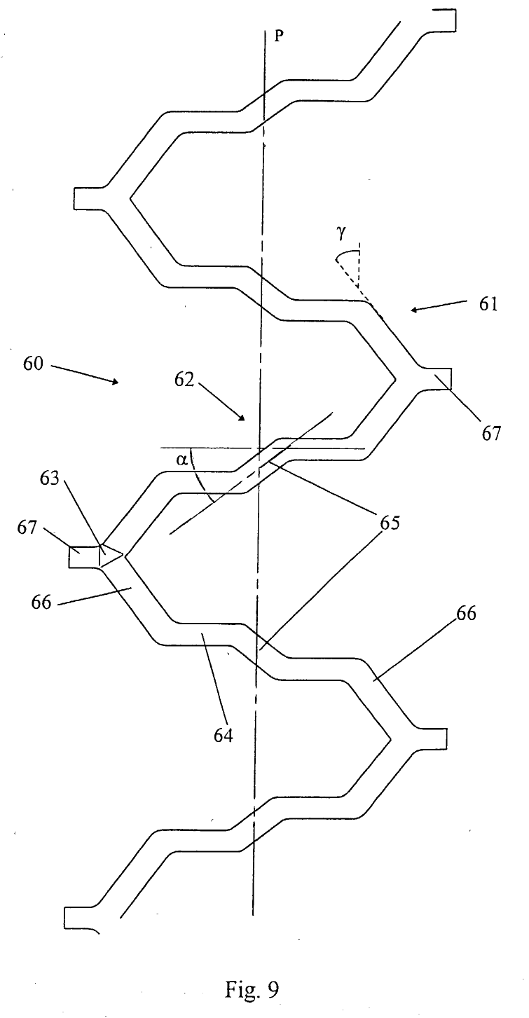

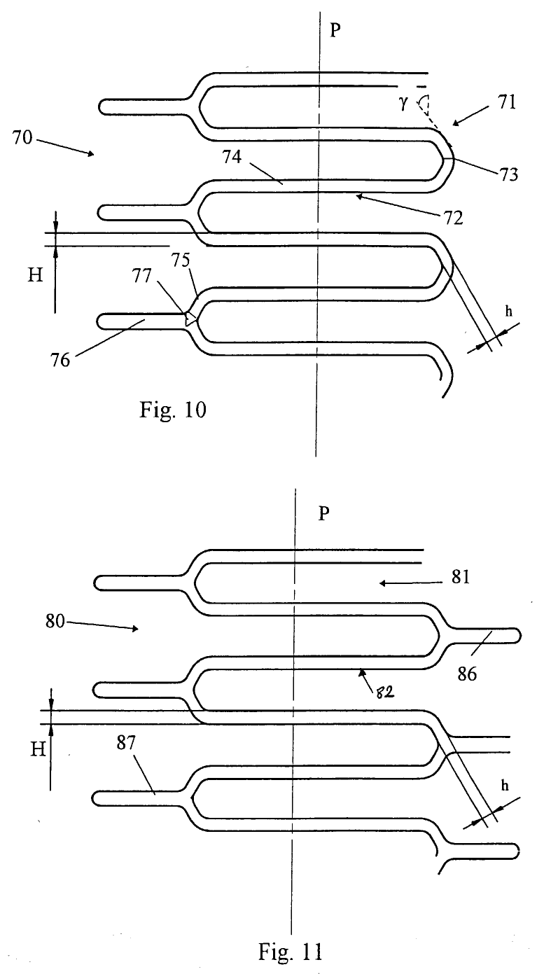

FIGS. 10 and 11, which are similar to FIG. 4, are respectively sectional views, along the line AA of FIG. 1, of annular bodies according to the invention including supporting elements having partitions which have variable thicknesses, and with axial shouldering walls,

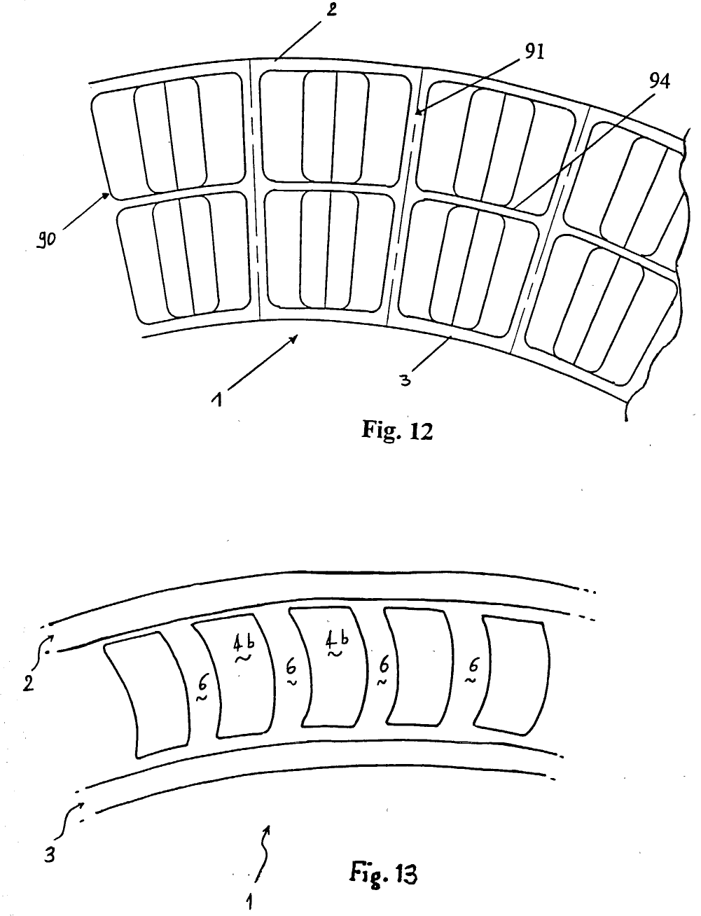

FIG. 12 is a side view of a support according to said second embodiment of the invention, the annular body of which comprises a central web, and

FIG. 13 is a perspective view showing a known support architecture.

In the following examples, “control” safety supports and safety supports according to the invention were manufactured, which differ from each other by the rubber compositions constituting them. The properties of the compositions were measured as follows:

Mooney viscosity MS (1+4) at 100° C.: measured in accordance with ASTM Standard D 1646 of 1999 by means of a small rotor;

fluidity: measured at the temperature of 90° C. in a fluidimeter, by a value of volume of the composition which has been preheated and premolded beforehand, which composition flows for a time of 11 seconds into a die of given geometry and under a load of 300 kg. This value of volume is expressed in units or points corresponding to graduations of 1/100 mm on the chamber of the fluidimeter.

More precisely, the die is formed of a conical upper part 1 mm in height and having a maximum diameter equal to 4.2 mm, which converges at an angle of 45° towards a cylindrical lower part 3 mm in height and having a diameter of 2.2 mm. This die is characterized by a roughness parameter Ra equal to 0.1 (Ra, arithmetic mean deviation of the profile to be characterized of the inner face of the wall, being defined in Standard NF/E05-015);

elasticity modulus M10 (conventional abbreviation which designates a secant modulus of extension obtained at a deformation of the order of 10%, at ambient temperature and upon the third stress cycle, in accordance with Standard ASTM D 412 of 1998). The corresponding tensile measurements are carried out under normal conditions of temperature and relative humidity in accordance with Standard ASTM D 1349 of 1999.

Hysteresis losses HL (60° C.): measured by rebound at 60° C. at the sixth impact, and expressed in % in accordance with the following equation:

PH(%)=100(W₀−W₁)/W₁,

with W₀: energy supplied and W₁: energy restored.

factor of hysteresis losses (tanδₘₐₓ): measured on a sample of material vulcanized by means of a Schenck machine, in accordance with Standard ASTM D 5992 of 1996. The response of this sample (cylindrical test piece of a thickness of 4 mm and a section of 400 mm²), subjected to an alternating single sinusoidal shearing stress, at a frequency of 10 Hz, under normal conditions of temperature (23° C.) in accordance with Standard ASTM D 1349 of 1999, was recorded. Scanning is effected at an amplitude of deformation of 0.1 to 50% (outward cycle), then of 50% to 1% (return cycle). For the return cycle, the maximum value of tanδ observed (tanδₘₐₓ) is indicated.

With reference to FIGS. 1 and 2, each of the supports 1 tested (“control” support and support in accordance with the invention) comprises essentially three parts:

a base 2, of generally annular shape;

a substantially annular crown 3, with (optionally) longitudinal grooves 5 on its radially outer wall, and

an annular body 4 for connecting the base 2 and the crown 3.

FIG. 2 illustrates in particular the function of a support 1, which is to support the tread of the tire in the event of a serious loss of inflation pressure therefrom.

These “control” supports and supports according to the invention have in common a width of 110 mm, an internal diameter of 460 mm and a height of 60 mm.

### “CONTROL” EXAMPLES

### I. “Control” Example 1

A first “control” safety support is formed of a vulcanized rubber composition such as defined below:

| | | | |
|---|---|---|---|
| elastomer: | natural rubber | 100 | phr; |
| reinforcing filler: | silica “ZEOSIL 1165 MP” | 70 | phr; |
| | (silica sold by Rhodia and having | | |
| | values of BET and CTAB | | |
| | surfaces of at least 150 | | |
| | to 160 m²/g); | | |
| coupling agent: | “Si69/carbon black N330”: | 11 | phr; |
| | (of which 5.5 phr of Si69 and 5.5 phr | | |
| | of carbon black N330); | | |
| “6PPD”: | | 2 | phr; |
| ZnO: | | 4 | phr; |
| stearic acid: | | 1 | phr; |
| vulcanization | | 3 | phr; |
| accelerator: “CBS”: | | | |
| sulphur: | | 4.5 | phr; |

in which “6PPD” is N-(1,3-dimethylbutyl)-N′-phenyl-p-phenylenediamine, and in which “CBS” is N-cyclohexyl-benzothiazyl-sulphenamide.

This first “control” support is manufactured in the following manner:

in a first, thermomechanical working, stage carried out in a 200-liter industrial mixer, all the constituents of the composition which are necessary including the coupling system and the various additives, with the exception of the vulcanization system, are kneaded. Thus in particular the elastomer and the reinforcing filler are mixed, the dropping temperature being approximately 155° C.;

in a second, mechanical working, stage, at a temperature less than 100° C., the sulphur vulcanization system is added to the mixture obtained at the end of said first stage;

in a third, vulcanization, stage carried out in an injection mold at a temperature of 150° C., the composition obtained at the end of said second stage is cured.

This first “control” support composition has, in the non-vulcanized state:

a Mooney viscosity MS (1+4) at 100° C. which is equal to 60, and

a fluidity which is equal to 200.

This composition furthermore has, in the vulcanized state:

an elasticity modulus M10 substantially equal to 17.5 MPa, and

hysteresis losses HL (60° C.) of 23.5, and

a factor of losses tanδₘₐₓ (at 40° C., return cycle)=0.25.

The first “control” support has an architecture which is illustrated in FIG. 9, in relation to FIGS. 1 and 2 (reference will be made to the part of the description entitled “architectures of supports according to the invention” for a detailed description of this architecture).

The section of FIG. 2 shows, for this “control” support, a first, solid, part 4a of the annular body 4 and also a second part 4b formed of cutouts (see also FIG. 1) extending axially over substantially more than half of the annular body 4, opening on to the outside in a substantially axial direction. These cutouts 4b are distributed regularly over the entire circumference of the annular body 4 and they define partitions 62 (see FIG. 9), which ensure a direct radial connection between the crown 2 and the base 3 of the support 1.

This geometry has the advantage of flexurally stressing, not compressively stressing, these partitions 62 when they are loaded. The cutouts 4b and therefore the partitions 62 are sufficiently numerous to provide regular support during travel in a support configuration.

More precisely, this first “control” support 1 comprises, over its circumference, 40 partitions 62 which each have a thickness of 15.7 mm, and which are spaced apart two by two by 41.4 mm.

Furthermore, the base 2 and the crown 3 have thicknesses which are equal to 7 mm and 8 mm respectively.

The mass of this first “control” support 7.3 is 5.7 kg.

### II. “Control” Example 2

A second “control” safety support was manufactured, the composition of which differs from that of the first “control” support solely in that it comprises a blend of natural rubber (60 phr) and polybutadiene (40 phr), the architecture, the dimensions and the mass of this support being identical to that of said first “control” support.

This second “control” support composition is substantially characterized by the same properties in the non-vulcanized state (MS(1+4) and fluidity) and in the vulcanized state (elasticity modulus M10, hysteresis losses PH (60° C.) and tanδₘₐₓ (40° C., return cycle)) as said first “control” support composition. EXAMPLES OF SAFETY SUPPORTS ACCORDING TO THE INVENTION:

1. Respective Compositions and Properties of these Safety Supports:

1) First Safety Support According to the Invention:

A first safety support according to the invention was manufactured, which consists of a vulcanized rubber composition having the same architecture as that of the aforementioned “control” supports (see FIG. 9).

This first support according to the invention is characterized by the following formulation for the vulcanized rubber composition which constitutes it:

| | | | |
|---|---|---|---|
| elastomer: | natural rubber | 100 | phr; |
| reinforcing filler: | silica “ZEOSIL 1165 MP” | 63 | phr; |
| coupling agent: | “Si69/carbon black N330” | 10.1 | phr; |
| | (of which 5.5 phr of Si69 and | | |
| | 5.5 phr of carbon black N330); | | |
| hollow glass microbeads: | | 15 | phr; |
| “6PPD”: | | 2 | phr; |
| ZnO: | | 4 | phr; |
| stearic acid: | | 1 | phr; |
| vulcanization | | 3 | phr; |
| accelerator: “CBS”: | | | |
| sulphur: | | 4.5 | phr; |

where the hollow glass microbeads which are used are sold by 3M under the generic name “3M Scotchlite® Glass Bubbles General Purpose Series”, the specific designation of these microbeads being “S60/10,000”.

These hollow microbeads have a nominal density (also referred to as absolute or true density) of 0.60 g/cm³, and they are majoritarily based on soda-lime borosilicate, which is present in a mass fraction of from 97% to 100%. These microbeads also comprise silicon dioxide, in a mass fraction less than or equal to 3%.

This vulcanized rubber composition is prepared in the following manner:

in a first, thermomechanical working, stage carried out in a 200-liter industrial mixer, all the constituents of the composition which are necessary including the coupling system and the various additives, with the exception of the vulcanization system, are kneaded. Thus in particular the elastomer, said reinforcing filler and said hollow microbeads are mixed, for approximately 4 minutes, at ambient temperature (temperature of introduction of the elastomer), the dropping temperature being approximately 155° C.;

in a second, mechanical working, stage, at a temperature less than 100° C. and for a time of between 2 min. and 2.5 min., the sulphur vulcanization system is added to the mixture obtained at the end of said first stage;

in a third, vulcanization, stage carried out in an injection mold at a temperature of 150° C. for approximately 8 min., the mixture obtained at the end of said second stage is cured.

It will be noted that the size distribution of the microbeads introduced into the internal mixer is as follows (percentages representing cumulative volume fractions; measurements taken in accordance with Standard ASTM D 1214):

| | |
|---|---|
| size <15 μm: | 10% |
| size <30 μm: | 50% |
| size <55 μm: | 90% |
| size <65 μm: | 95% |

This first support composition according to the invention has the following properties:

Mooney viscosity MS(1+4)=51;

fluidity=220;

elasticity modulus M10=16 MPa

hysteresis losses HL (60° C.)=19, and

tanδₘₐₓ (at 40° C., return cycle)=0.17

It should be noted that this first support composition according to the invention has:

a processing ability which is improved in relation to the injection-molding operation compared with that of the aforementioned compositions of “control” supports, owing to its Mooney viscosity which is distinctly less than that of said “control” compositions and its increased fluidity relative to that of the latter,

reduced hysteresis losses compared with those of said “control” compositions. The result is lesser potential heating when travelling with a flat tire of the support made from this first composition according to the invention and, consequently, a possibility of increased endurance when travelling with a flat tire of this first support according to the invention, and

high rigidity in the vulcanized state.

It will also be noted that the reinforcing white filler, such as silica, which is preferably used in the rubber composition according to the invention, contributes to providing this composition with improved properties in the cured state, such as cohesion.

2) Second Safety Support According to the Invention:

A second safety support according to the invention was manufactured, which is formed of a vulcanized rubber composition having the same architecture as previously (see FIG. 9), and which differs from said first support according to the invention solely in that its composition comprises, as elastomeric matrix, a blend of natural rubber (60 phr) and of polybutadiene (40 phr).

The second support composition according to the invention has the following properties:

Mooney viscosity MS(1+4)=48;

elasticity modulus M10=16 MPa; and

tanδₘₐₓ (at 40° C., return cycle)=0.16.

This second composition according to the invention therefore has substantially the same properties in the non-vulcanized state (improved processing ability) and in the vulcanized state (reduced hysteresis losses) as said first composition according to the invention.

3) Third Safety Support According to the Invention:

A third safety support according to the invention was manufactured, which is formed of a vulcanized rubber composition having the same architecture as previously, and which differs from said first support according to the invention solely in that its composition comprises said hollow microbeads in a quantity of 25 phr (instead of 15 phr), and said silica “ZEOSIL 1165 MP” in a quantity of 61 phr (instead of 63 phr).

As previously, this third support composition according to the invention has substantially the same properties in the non-vulcanized state (MS(1+4)) and in the vulcanized state (M10, HL (60° C.) and tanδₘₐₓ (at 40° C., return cycle)) as the preceding compositions according to the invention.

4) Fourth Safety Support According to the Invention:

A fourth safety support according to the invention was manufactured, which is formed of a vulcanized rubber composition having the same architecture as previously, and which differs from said second support according to the invention solely in that its composition comprises said hollow microbeads in a quantity of 25 phr (instead of 15 phr), and said silica “ZEOSIL 1165 MP” in a quantity of 61 phr (instead of 63 phr).

As previously, this third support composition according to the invention has substantially the same properties in the non-vulcanized state (MS(1+4)) and in the vulcanized state (M10, HL (60° C.) and tanδₘₐₓ (at 40° C., return cycle)) as the preceding compositions according to the invention.

5) Fifth Safety Support According to the Invention:

A fifth safety support according to the invention was manufactured, which is constituted of a vulcanized rubber composition having the same architecture as previously, and which differs from said first support according to the invention solely in that:

its composition comprises, in a quantity of 20 phr, solid glass microbeads instead of the 15 phr of hollow microbeads,

the quantity of coupling agent “Si69/Black N330” is 10.4 phr instead of 10.1 phr, and in that

the quantity of silica used is 65 phr instead of 63 phr.

These solid microbeads are sold by POTTERS BALLOTINI under the name “4-45”, and they have a size distribution which is such that their minimum diameter is 4 μm and their maximum diameter is 45 μm. The average density of these solid microbeads is 2.48.

The process for manufacturing this fifth support is similar to the aforementioned one in relation to the hollow microbeads.

The properties of this fifth support composition are as follows:

Mooney viscosity MS(1+4)=47;

elasticity modulus M10=16 MPa;

Hysteresis losses HL (60° C.)=20.5;

tanδₘₐₓ (at 40° C., return cycle)=0.19.

This fifth composition according to the invention therefore also has an improved processing ability, and also hysteresis and physical properties which are also improved in the vulcanized state, thus making it suitable for forming a safety support having improved endurance.

6) Sixth Safety Support According to the Invention:

A sixth safety support according to the invention was manufactured, which is formed of a vulcanized rubber composition having the same architecture as previously, and which differs from said fifth support according to the invention solely in that the size distribution of the solid microbeads is such that their minimum diameter is 75 μm and that their maximum diameter is 150 μm.

The properties of this sixth support composition are as follows:

Mooney viscosity MS(1+4)=47;

elasticity modulus M10=16 MPa;

tanδₘₐₓ (at 40° C., return cycle)=0.20.

This sixth composition according to the invention therefore also has an improved processing ability, and also hysteresis and physical properties which are also improved in the vulcanized state, thus making it suitable for forming a safety support having improved endurance.

II. Examples of Architectures Usable for said Supports According to the Invention:

In addition to the preferred architecture, illustrated in FIG. 9, which was mentioned in section I. and will be described in the present section II, other advantageous examples of architectures of supports which can used for the present invention are presented hereafter.

A first embodiment of preferred architecture of a support according to the invention is illustrated in FIG. 3.

As has been previously indicated generally, with reference to FIGS. 1 and 2, a safety support 1 according to FIG. 3 is of the type comprising said base 2, said crown 3 and said annular body 4.

There is shown in FIG. 3 a supporting element 7 for this preferred support 1 which is circumferentially continuous, said supporting element comprising a plurality of partitions 6 extending axially on either side of the circumferential median plane P of the support 1 and being distributed over the circumference of said support 1.

It can be seen in FIG. 3 that this supporting element 7 comprises, in one of said sides of the support 1, joining elements 8 extending substantially circumferentially. Each joining element 8 connects together the respective ends 6a of two adjacent partitions 6 which are arranged on said side of the support 1, and said joining elements 8 are arranged successively alternately on either side of said partitions 6.

More precisely, the joining elements 8 are provided with a mutual shoulder, between two adjacent partitions 6, by a rib 8a extending from said crown 3 to said base 2 of the support 1, such that said joining elements 8 form a continuous joining wall 9 in the form of a bellows over the entire side of said support 1.

More precisely, said joining wall 9 comprises a plurality of cells 9a which are each defined by two adjacent ribs 8a. The bottom of each cell 9a has substantially the form of a dihedron, the edge of which is formed by one end 6a of the partition 6, and the faces of which are respectively formed by said alternating joining elements 8.

In this preferred example of architecture tested, the partitions 6 of the support 1 are 40 in number over the circumference of said support 1, and they each have a thickness of 8 mm, and are spaced apart from each other by 40 mm. And as has been stated above for each support 1 tested, the latter has a width of 135 mm, a diameter of 440 mm and a height of 50 mm.

Furthermore, the base 2 and the crown 3 of said support 1 have thicknesses which are equal to 6 mm and 7 mm respectively.

Furthermore, the distance in the axial direction between a plane P′, which is axially median for said joining elements 8, and the respective free ends of said ribs 8a, is equal to 20 mm in this preferred example.

A second embodiment of architecture of a support 1 according to the invention is shown in FIG. 4, FIGS. 5 to 12 for their part showing variants of this second embodiment (the structural elements analogous to those of FIG. 4 are identified hereafter by numerical references which are increased by 10 in each Fig., starting from FIG. 5).

As in said first embodiment, the supports 1 relating to these FIGS. 4 to 12 are all of the type comprising said base 2, said crown 3 and an annular body 10.

FIG. 4 shows such an annular body 10. The latter is formed of a circumferentially continuous supporting element 11, which comprises a set of partitions 12 connected two by two by joining elements 13.

The partitions 12 extend laterally on either side of the circumferential median plane P of the support 1, and they are regularly distributed over the circumference of said support 1. They have an inclination Δ, relative to the circumferential direction, which is close to 90 degrees. Their thickness H is constant. Furthermore, two adjacent partitions 12 have an opposed inclination relative to the axial direction.

These joining elements 13 have a thickness e, they are oriented circumferentially and each connect between them the respective ends of two adjacent partitions 12 which are arranged on the same side of the support 1 (these two ends are the closest to each other).

The joining elements 13 are thus arranged successively alternately on either side of the partitions 12.

It will be noted that the supporting element 11 does not comprise any undercut element, to facilitate the manufacture of the support 1 with axial demolding.

FIG. 5 shows a variant embodiment of a supporting element 21, with reference to the supporting element 11 of FIG. 4.

The partitions 22 of this supporting element 21 have a thickness H, in their central part, which is greater than their thickness h, at the location of their lateral ends. In this example, H is approximately twice as large as h.

This variation in thickness gives the central parts of the partitions 22 very good resistance to buckling. As for the lateral ends, they are connected continuously to the joining elements 23, which impart thereto good resistance to buckling.

It will be noted that a variation in thickness of as little as 10% may have appreciable effects, in relation to delaying the appearance of overload buckling.

FIG. 6 shows another variant embodiment of a supporting element 31.

This comprises, as previously, a set of partitions 32 which are connected by joining elements 33. The partitions 32 comprise two lateral parts 34 of the same inclination A relative to the circumferential direction, which are offset circumferentially and which are connected in the central part of said supporting element 31 by a third part 35 of substantially circumferential orientation.

The variation α in average orientation between the lateral parts 34 and the central part 35 is here of the order of 80 degrees. As the parts 35 are of circumferential orientation, the angles α and Δ are equal.

The presence of this third central part 35, of an average orientation very different from that of the two lateral parts, reinforces the resistance to buckling of the central part of the partitions 22.

It will be noted that this variation α, in order to be effective, must be greater than 20 degrees.

In this example of embodiment, the partitions 32 comprise, from one lateral end to the other, an inversion of their direction of curvature.

FIG. 7 shows another variant embodiment of a supporting element 41.

The joining elements 43 which are arranged on one side of the supporting element 41 here have a circumferential length which is less than that of the joining elements 44, which are arranged on the other side of the supporting element 41.

It will be noted that the substantially doubled length of the joining elements 44 increases the stiffness in compression of the supporting element 41, on this side of the support 1. This same side is to be arranged on the inner side of the vehicle, where the forces to which the support 1 is subjected in operation are the greatest.

FIG. 8 shows another variant embodiment of a supporting element 51.

The joining elements 53 are here practically reduced to the contact surface between the two lateral ends 54, in the form of an arc of a circle, of the partitions 52.

These partitions 52 also comprise a central connecting part 55.

It will be noted that the variation (x in average orientation between the two lateral parts 56 and the central part 55 is greater than 90 degrees and is of the order of 110 degrees, which increases the average density of support of the supporting element 51 in its central part.

These partitions 52 comprise, from one lateral end to the other, three inversions of their direction of curvature.

FIG. 9 shows another variant embodiment of a supporting element 61, which variant is close to that of FIG. 8 with the following modifications.

The partitions 62 comprise rectilinear segments and have three inversions of their direction of curvature. They comprise two lateral parts of axial orientation 64, which are connected, on one hand, to each other by a central part 65 and, on the other hand, to the joining elements 63 by lateral ends 66 of average orientation γ close to 30 degrees, relative to the circumferential direction.

The variation α in average orientation which exists between the two parts 64 of axial orientation of the partitions 62 and the central joining part 65 is of the order of 60 degrees.

The joining elements 63 may be defined here as being elements of substantially triangular section, which are arranged between two adjacent lateral ends 66.

On both sides of the supporting element 61, the annular body 60 comprises a set of walls of substantially axial orientation 67 which extends each joining element 63 towards the outside of the support 1. As can be seen in this FIG. 9, the joining of each joining element 63, said adjacent lateral ends 66 and said axial wall 67 thus forms a star having three branches, which is very resistant to buckling.

FIG. 10 shows another variant embodiment of an annular body 70 and, consequently, of a supporting element 71.

The latter comprises partitions 72 with central parts 74 of axial orientation which are extended on either side by a lateral end 75, which has an orientation γ close to 30 degrees relative to the circumferential direction.

The joining elements 73, on one side of the annular body 70, are reduced to the contact surface between the two adjacent lateral ends 75. On the other side, the annular body 70 comprises lateral walls 76 which provide a shoulder on this side for the joining elements 77, which have a substantially triangular shape.

It will be noted that on this latter side, the stiffness in compression of the supporting element is greater.

The length of the lateral walls 76 is significantly less than half of the length of the central parts 74 of the partitions 72, so that they are not liable to buckle.

Preferably, the side of the supporting element 71 the stiffness in radial compression of which is higher is to be arranged on the inside of the vehicle, because it was noted that the forces are greatest on this inner side of the vehicle.

The partitions 72 have a thickness H in their central part 74 which is greater than the thickness h of their lateral parts 75, so as to reinforce the resistance to buckling of this central part 74.

FIG. 11 shows another variant embodiment of an annular body 80, which variant is very close to said annular body 70 of FIG. 10.

This annular body 80 comprises axial lateral walls 86 and 87 which provide a shoulder on both sides for the supporting element 81, which is also structurally very close to said supporting element 71.

For a given width of annular body 80, these lateral walls 86 and 87 have the advantage of reducing the axial width of the partitions 82 of the continuous supporting element 81, and thus of improving the resistance to buckling of the entire structure. The axial lengths of said walls 86 and 87 may be different, as shown in FIG. 11.

FIG. 12 shows an axial view of a support 1 including a supporting element 91 such as described in FIG. 11, but furthermore comprising a continuous circumferential web 94 which is arranged at half the height of the annular body 90. This circumferential web 94, of cylindrical shape, has the advantage of providing a very significant increase, of the order of a factor of four, of the limit buckling load of the structure of the support 1.

Each of the supports 1 described with reference to FIGS. 4 to 12 has the following dimensional characteristics.

The partitions 12, . . . , 92 are 40 in number over the circumference of said support 1, and they each have a thickness of 8 mm, and are spaced apart from each other by 40 mm. And as has been stated above for each support 1 tested, the latter has a width of 135 mm, a diameter of 440 mm and a height of 50 mm.

Furthermore, the base 2 and the crown 3 of said support 1 have thicknesses which are equal to 6 mm and 7 mm respectively.

All the supporting elements 7, 11, . . ., 91 and the annular bodies 4, 10, . . . , 90 shown above can be produced by molding techniques. Preferably they do not comprise any undercut part, in order to facilitate axial demolding.

It will be noted that there could also be used, as architecture of supports according to the invention, a support consisting of a plurality of rings connected together in the axial direction of said support, its overall structure being unchanged.

Provision could for example be made for such a support to have a first ring of substantially rectangular axial section, and one or more annular elements having a plurality of cutouts and extending substantially axially over their entire widths and substantially regularly distributed over their circumferences.

Such a ringed support is easier to introduce into a tire, owing to the lesser flexural rigidity of its different annular elements.

1. A rubber composition, usable in the vulcanized state as a safety support intended to be mounted on a wheel rim within a tire, said composition comprising at least one diene elastomer, characterized in that it also comprises (phr: parts by weight per 100 parts of diene elastomer(s)):
solid or hollow glass microbeads, in a quantity of from 5 to 50 phr,
more than 40 phr of reinforcing filler, and
3 to 8 phr of sulphur.

2. A rubber composition according to claim 1, characterized in that said reinforcing filler comprises majoritarily a reinforcing white filler.

3. A rubber composition according to claim 2, characterized in that said reinforcing white filler consists of silica, in a quantity of from 40 to 80 phr.

4. A rubber composition according to claim 2, characterized in that it comprises a reinforcing white filler/elastomer bonding agent which is of the polysulphurized alkoxysilane type.

5. A rubber composition according to claim 1, characterized in that said microbeads are solid microbeads which are present in said composition in a quantity of from 5 phr to 50 phr.

6. A rubber composition according to claim 1, characterized in that said microbeads are hollow microbeads which are present in said composition in a quantity of from 5 phr to 50 phr.

7. A rubber composition according to claim 6, characterized in that the volume mass of said hollow microbeads is equal to or greater than 0.55 g/cm³.

8. A rubber composition according to claim 1, characterized in that the average volume size of said solid or hollow microbeads is between 10 μm and 400 μm.

9. A rubber composition according to claim 1, characterized in that it comprises a single diene elastomer which consists of natural rubber or synthetic polyisoprene.

10. A rubber composition according to claim 1, characterized in that it comprises a blend:
in a quantity equal to or greater than 60 phr, of natural rubber or synthetic polyisoprene, and
in a quantity less than or equal to 40 phr, a material selected from the group consisting of: a homopolymer obtained by polymerization of a conjugated diene monomer having 4 to 12 carbon atoms; and a copolymer obtained by copolymerization of one or more dienes conjugated together or with one or more vinyl aromatic compounds having from 8 to 20 carbon atoms.

11. A rubber composition according to claim 10, characterized in that said blend is formed of approximately 60 phr natural rubber and approximately 40 phr polybutadiene.

12. A rubber composition according to claim 1, characterized in that it has an elasticity modulus M10 at 10% deformation which is greater than 10 MPa.

13. A process for the preparation of a rubber composition in the vulcanized state according to claim 1, characterized in that it comprises,
in a first, thermomechanical working, stage, of kneading said elastomer, said reinforcing filler and said solid or hollow glass microbeads, the dropping temperature being approximately 155° C., then
in a second, mechanical working, stage, of adding a sulphur vulcanization system to the mixture obtained at the end of said first stage, then
in a third, vulcanization, stage, of curing the mixture obtained at the end of said second stage,
such that said microbeads are dispersed in said elastomer.

14. A preparation process according to claim 13, characterized in that it comprises,
in said second stage, of effecting said addition at a temperature less than 100° C., then
in said third stage, of effecting said curing at a temperature of between 140° C. and 170° C.

15. A safety support intended to be mounted on a wheel rim within a vehicle tire including a tread, so as to be able to support a tread of said tire in the event of a drop in inflation pressure, characterized in that said support is formed of a vulcanized rubber composition according to claim 1.

16. A safety support according to claim 15, comprising:
a base intended to be mounted on said rim,
a substantially cylindrical crown intended to come into contact with said tread in the event of a drop in pressure, and leaving a clearance relative to said tread at nominal pressure, and
an annular body connecting said base and said crown, said body comprising a supporting element circumferentially continuous with a circumferential median plane, said supporting element comprising:
a plurality of partitions extending axially on either side of said circumferential median plane and distributed over the circumference of said support,
joining elements extending substantially circumferentially in one of said sides of the support, each joining element connecting together the respective ends of two adjacent partitions which are arranged on said side of the support, said joining elements being arranged successively alternately on either side of said partitions,
characterized in that, between two adjacent partitions, said joining elements are provided with a mutual shoulder by a rib extending from said crown to said base of the support, such that said joining elements form a continuous joining wall in the form of a bellows over the entire side of said support.

17. A safety support according to claim 16, characterized in that said continuous wall comprises a plurality of cells which are each defined by two adjacent ribs, the bottom of each cell having substantially the form of a dihedron, the edge of which is formed by one of said partitions and the faces of which are respectively formed by said alternating joining elements.

18. A safety support according to claim 15, comprising:
a base intended to be mounted on said rim,
a substantially cylindrical crown intended to come into contact with said tread in the event of a drop in pressure, and leaving a clearance relative to said tread at nominal pressure, and
an annular body connecting said base and said crown, said body comprising a supporting element which is circumferentially continuous with a circumferential median plane, said supporting element comprising:
a plurality of partitions extending axially on either side of said circumferential median plane and distributed over the circumference of said support, wherein said partitions have central parts and lateral ends, and
joining elements extending substantially circumferentially, each joining element connecting together the respective ends of two adjacent partitions which are arranged on the same side of the support, said joining elements being arranged successively alternately on either side of said partitions,
characterized in that said partitions are adapted in their central part relative to their lateral ends to reinforce the resistance to buckling under radial loading of said annular body.

19. A safety support according to claim 18, characterized in that the ratio between the thickness of said partitions in their central part and their lateral ends is greater than 1.1.

20. A safety support according to claim 18 further comprising wherein said partitions have curvature, characterized in that said partitions have, from one lateral end to the other, at least one inversion of the direction of their curvature.

21. A safety support according to claim 20 wherein said support further includes a circumferential direction, characterized in that said partitions have a central part extending substantially axially between two lateral parts, said lateral parts joining the joining elements and forming an angle γ of from 20 to 40 degrees with the circumferential direction.

22. A safety support according to claim 18, further comprising wherein said partitions have curvature, characterized in that said partitions have, from one lateral end to the other, at least three inversions of their direction of curvature.

23. A safety support according to claim 20, characterized in that said partitions have, in their central zone, two parts extending substantially axially and offset circumferentially relative to one another, and also a third joining part.

24. A safety support according to claim 18, further comprising that, on one side at least of said supporting element, each joining element is provided with a shoulder by at least one wall extending substantially axially towards the outside of said annular body.

25. A safety support according to claim 24, further comprising an axial wall and adjacent partitions, characterized in that each joining element forms with an axial wall which provides it with a shoulder and the lateral ends of the two adjacent partitions an assembly in the form of a star having three branches.

26. A safety support according to claims 18, characterized in that the supporting element furthermore comprises a web which is substantially cylindrical and coaxial with the support which is arranged radially at half the height of said supporting element.

27. A safety support according to claims 18, characterized in that the supporting element is adapted so as not to comprise any undercut part which might oppose axial demolding of the support.

28. A mounted assembly for an automobile, comprising a wheel rim including peripheral edges and two seats including a flange, a tire mounted on said rim, which tire includes a bead and a tread, and a safety support mounted on said rim within said tire so as to be able to support a tread of said tire in the event of a drop in inflation pressure, said rim comprising in each of its two peripheral edges a rim seat intended to receive a bead of said tire, said rim comprising between its two seats, on one hand, a bearing surface and, on the other hand, a mounting groove connecting said bearing surface to an axially inner flange of one of said seats, or first seat, characterized in that said support is as defined in claim 15.
